(19) United States
(12) Patent Application Publication
(10) Pub. No.: US 2012/0157028 A1
(43) Pub. Date: Jun. 21, 2012

(54) APPARATUS AND METHOD FOR PROVIDING INFORMATION IN PORTABLE TERMINAL

(75) Inventors: Jong-Hwan OH, Daegu (KR); Jun-Hyo PARK, Gyeongsangbuk-do (KR); Jun-Wook JEONG, Gyeongsangbuk-do (KR)

(73) Assignee: SAMSUNG ELECTRONICS CO., LTD., Gyeonggi-Do (KR)

(21) Appl. No.: 13/331,103

(22) Filed: Dec. 20, 2011

(30) Foreign Application Priority Data
Dec. 21, 2010 (KR) 10-2010-0131244

(51) Int. Cl. H04B 1/06

(52) U.S. Cl. 455/230

(57) ABSTRACT

Provided is an apparatus and method for providing information in a portable terminal having a display unit and a control unit. The display unit displays an information providing window for information received from a broadcasting station during a radio play mode of the portable terminal. The control unit provides a particular function responsive to the information received from the broadcasting station during the radio play mode of the portable terminal.

### CLAIM OF PRIORITY

This application claims the benefit under 35 U.S.C. §119 of a Korean Patent Application filed in the Korean Intellectual Property Office on Dec. 21, 2010 and assigned Serial No. 10-2010-0131244, the entire disclosure of which is hereby incorporated by reference.

### BACKGROUND OF THE INVENTION

1. Field of the Invention

The present invention relates generally to an apparatus and method for providing information in a portable terminal, and more particularly, to an apparatus and method for enhancing a utilization of a portable terminal.

2. Description of the Related Art

Radio Data System (RDS) denotes digital information carried in FM radio transmission standardized by European Broadcasting Union (EBU). Examples of the RDS include Program Service (PS), Alternative Frequency (AF), Radio Text (RT), Traffic Announcement (TA), and Traffic Program (TP), the exemplary use of which is illustrated in FIG. 1.

The RT is plain text information transmitted by a broadcasting station to provide users with additional information such as Song Title and Singer Name. The RT provides additional information in some channels, but fails to indicate the type of information in a given text.

Recently, the spec of the RDS has been updated to provide RT+ that allows room for various uses of the RT. The RT+ provides additional tag information indicating the type of RT information, and extends the range of RT information. Table 1 below shows an example of an RT+ message format.

TABLE 1
INFO.STOCKMARKET
[Name_{——}Latest value in [symbol] ] or more extended:
[Name_{——}Latest value in [symbol] _{——}Change_{——}High_{——}Low_{——}Volume]
e.g.
‘Nokia_{——}12.27_{——}0.41_{——}12.31_{——}12.15_{——}23.332.238’
INFO.SPORT
[Match_{——}Result] or more extended:
[Kind of Sport_{——}Match_{——}Result] e.g.
‘Football_{——}Bayern Munchen:AC Milano_{——}5:5’
INFO.WEATHER
[Description_{——}Temperature] e.g.
‘Raining_{——}16 Grad C’ or
‘Munich_{——}23 Grad C’
Interactivity
PHONE.OTHER
[Description_{——}Phone Number] e.g.
‘Deutsches Museum_{——}089323990’

As shown above, the RT+ provides a content type list of various formats, thereby making it possible to provide a variety of information reflecting the current channel characteristics and transmit communication data.

Also, the text of RT+ is provided together with tag information, thus making it possible to detect the type of information carried in the text.

Thus, the RT+ can be used to provide users with a variety of additional information. Therefore, there is a need to provide a new scheme to use the RT+ to enhance the application of a portable terminal.

### SUMMARY OF THE INVENTION

An exemplary embodiment of the present invention is to provide an apparatus and method for providing information in a portable terminal, which can provide convenient functions in the portable terminal by using RT+ information received in a radio play mode of the portable terminal.

Another exemplary embodiment of the present invention is to provide an apparatus and method for providing information in a portable terminal, which can control data of the portable terminal by using RT+ information received in a radio play mode of the portable terminal.

Another exemplary embodiment of the present invention is to provide an apparatus and method for providing information in a portable terminal, which can control a connection to a broadcasting station in the portable terminal by using RT+ information received in a radio play mode of the portable terminal.

According to an aspect of the present invention, an apparatus for providing information in a portable terminal includes: a display unit for displaying an information providing window for information received from a broadcasting station in a radio play mode of the portable terminal; and a control unit for providing a function by using the information received from the broadcasting station in the radio play mode of the portable terminal.

According to another aspect of the present invention, a method for providing information in a portable terminal includes: determining whether information is received from a broadcasting station in a radio play mode of the portable terminal; and upon receiving the information from the broadcasting station, providing a function by using the received information.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a diagram illustrating a radio play screen picture displayed in a radio play mode of a conventional portable terminal;

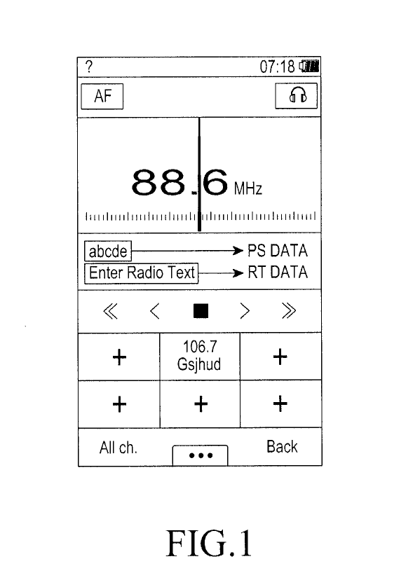

FIG. 2 is a block diagram of a portable terminal according to an exemplary embodiment of the present invention;

FIG. 3 is a flow diagram illustrating a process for performing a function provided using information received in a radio play mode of a portable terminal according to an exemplary embodiment of the present invention; and

FIGS. 4A to 4D are diagrams for describing the process of FIG. 3.

### DETAILED DESCRIPTION OF THE INVENTION

Exemplary embodiments of the present invention will be described below in detail with reference to the accompanying drawings. The present invention may, however, be embodied in different forms and should not be construed as limited to the embodiments set forth herein; rather, these embodiments are provided so that this disclosure will be thorough and complete, and will fully convey the scope of the present invention to those skilled in the art.

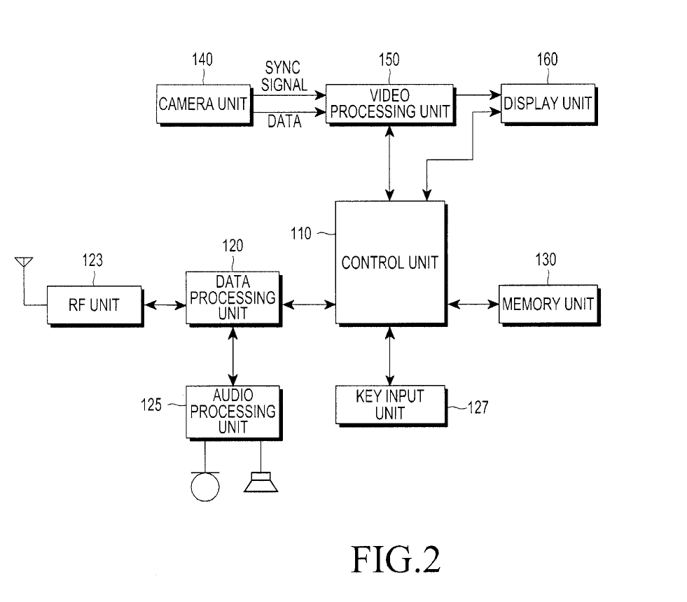

FIG. 2 is a block diagram of a portable terminal according to an exemplary embodiment of the present invention.

Referring to FIG. 2, a portable terminal according to an exemplary embodiment of the present invention includes a control unit 110, a data processing unit 120, a radio frequency (RF) unit 123, an audio processing unit 125, a key input unit 127, a memory unit 130, a camera unit 140, a video processing unit 150, and a display unit 160.

The RF unit 123 performs a wireless communication function of the portable terminal. The RF unit 123 includes an RF transmitter for upconverting and amplifying a transmission (TX) signal, and an RF receiver for low-noise-amplifying and downconverting a received (RX) signal.

The data processing unit 120 includes a transmitter for encoding and modulating the TX signal, and a receiver for demodulating and decoding the RX signal. For example, the data processing unit 120 includes a modem and a codec. Herein, the codec includes a data codec for processing packet data, and an audio codec for processing audio signals (e.g., voice signals).

The audio processing unit 125 processes an RX audio signal outputted from the audio codec of the data processing unit 120, and transmits a TX audio signal, generated by a microphone, to the audio codec of the data processing unit 120.

The key input unit 127 includes keys for inputting numeral and character information, and function keys for setting various functions.

The memory unit 130 may include a program memory and a data memory. The program memory may store programs for controlling a general operation of the portable terminal, and programs for providing convenient functions by using RT+ information received in a radio play mode of the portable terminal.

The control unit 110 controls an overall operation of the portable terminal.

According to an exemplary embodiment, the control unit 110 provides convenient functions by using information received from a broadcasting station in a radio play mode of the portable terminal. As explained in details later, the control unit 110 displays an information providing window corresponding to the type of information received from the broadcasting station in a radio play mode of the portable terminal. The information providing window may be displayed in a predetermined region of a radio play screen displayed in the radio play mode, or may be displayed in the form of a pop-up window.

The information received from the broadcasting station may be RT+ information. The RT+ information may include a variety of text information and tag information indicating the type of the text information.

The tag information may include Content Type and Text Location Information (e.g., Start Marker and Length Marker).

The Content Type list may include ITEM, INFO, PROGRAM and INTERACTIVITY.

The ITEM provides music information such as ITEM.TITLE and ITEM.ARTIST. The INFO provides a variety of information such as INFO.NEWS, INFO.WEATHER and INFO.URL. The PROGRAM provides program schedule information such as PROGRAM.NOW and PROGRAM.NEXT. The INTERACTIVITY provides communication information such as PHONE.STUDIO, SMS.STUDUO and EMAIL.STUDIO.

Thus, according to an exemplary embodiment, if the type of contents included in the tag information of the RT+ information received from the broadcasting station in the radio play mode is music information (ITEM), the control unit 110 selectively displays an information providing window for the music information on the display unit 160.

In order to download in-play music (or music being played) by using the music information, the control unit 110 displays a music download menu for providing a link to a service provider server and an information search menu for searching the portable terminal and a search site for the music information, in the information providing window for the music information.

In operation, when the type of contents included in the tag information of the RT+ information received from the broadcasting station is music information (ITEM), if a recording menu for the in-play music is selected in the radio play mode, the control unit 110 stores the in-play music by automatically designating the music information (e.g., Song Title (ITEM.TITLE)) as the music storage name.

Herein, the control unit 110 inserts the music information (Song Title (ITEM.TITLE), Singer Name (ITEM.ARTIST) and Text Location Information (Start Marker and Length Marker)) into the stored music tag. Thus, while the stored music is being played, the Singer Name and the Song Title may be displayed using the music information inserted into the music tag.

Moreover, according to an exemplary embodiment, when the type of contents included in the tag information of the RT+ information received from the broadcasting station is communication information (INTERACTIVITY), the control unit 110 selectively displays an information providing window corresponding to the type of the communication information (Phone/Text Message (PHONE.STUDIO/PHONE.SMS), Access Site (WEBSITE.STUDIO), and E-mail (EMAIL.STUDIO)).

The control unit 110 provides the information providing window corresponding to the type of the communication information, thereby enabling a connection to the broadcasting station through the communication function.

As described above, the control unit 110 displays an appropriate information providing window for providing functions corresponding to the types of contents included in the tag information of the RT+ information. Accordingly, the portable terminal can provide various convenient functions by using the tag information of the RT+ information.

Referring back to FIG. 2, the camera unit 140 includes a camera sensor for capturing video data and converting the video data into an electrical signal, and a signal processing unit for converting an analog video signal, captured by the camera sensor, into digital data. The camera sensor may include a CCD sensor or a CMOS sensor, and the signal processing unit may include a digital signal processor (DSP). Also, the camera sensor and the signal processing unit may be integrated into one unit, or may be separated from each other.

The video processing unit 150 performs an image signal processing (ISP) operation to display video signals, outputted from the camera unit 140, on the display unit 160. Examples of the ISP operation include gamma correction, interpolation, spatial change, image effects, image scaling, auto white balance (AWB), auto exposure (AE), and auto focus (AF). The video processing unit 150 processes the video signals, outputted from the camera unit 140, on a frame basis, and outputs the frame video data according to the size and characteristics of the display unit 160. Also, the video processing unit 150 includes a video codec to compress the frame video data displayed on the display unit 160 and restore the compressed frame video data into the original frame video data. The video codec may include a JPEG codec, an MPEG4 codec, or a Wavelet codec. The video processing unit 150 may have an on-screen display (OSD) function to output OSD data in accordance with a display screen size under the control of the control unit 110.

The display unit 160 displays the video signal outputted from the video processing unit 150, and displays the user data outputted from the control unit 110. The display unit 160 may be implemented using an LCD. If the display unit 160 is implemented using an LCD, the display unit 160 may include an LCD, an LCD controller, and a memory for storing video data. The LCD may be a touchscreen LCD. If the LCD is a touchscreen LCD, it may also operate as an input unit. Also, the display unit 160 may display the keys of the key input unit 127.

According to an exemplary embodiment, the display unit 160 displays an information providing window corresponding to RT+ information received from the broadcasting station in a radio play mode of the portable terminal.

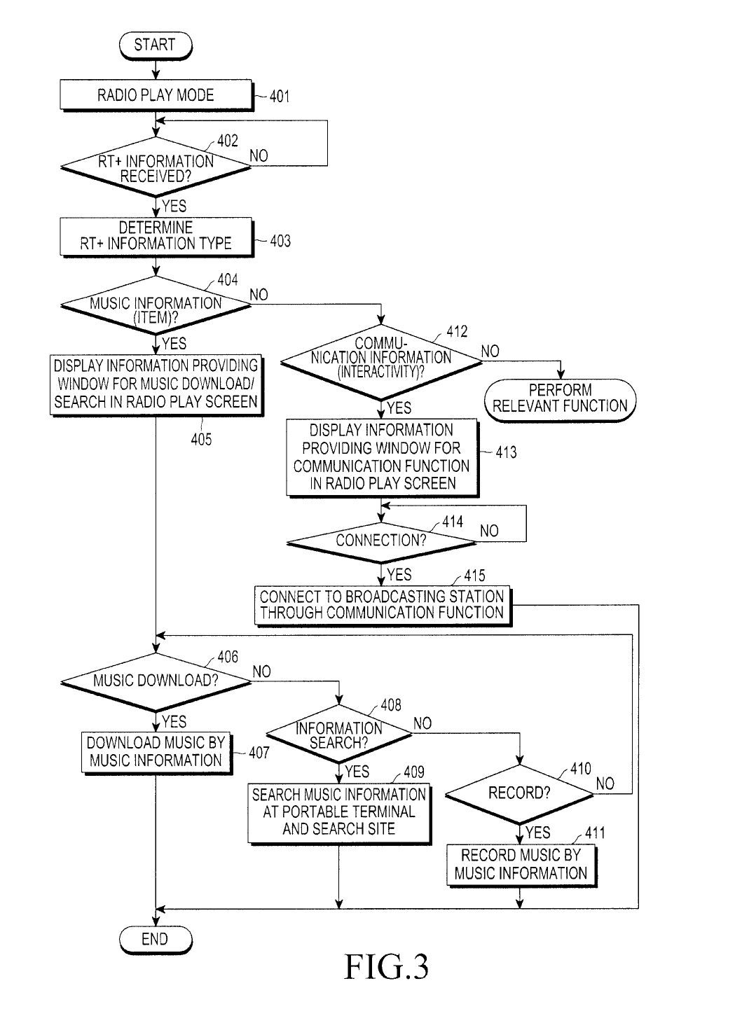

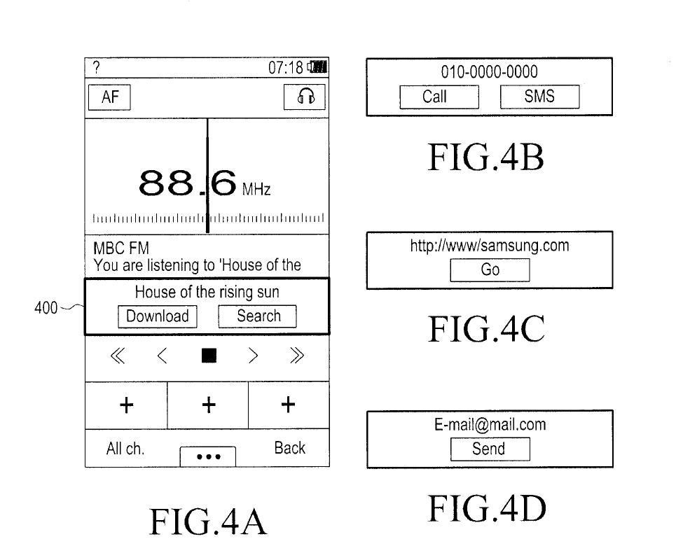

Hereinafter, the process for performing a function provided using information received in a radio play mode of the portable terminal according to an exemplary embodiment of the present invention will be described in detail with reference to FIGS. 3 and 4A to 4D.

FIG. 3 is a flow diagram illustrating a process for performing a function provided using information received in a radio play mode of the portable terminal according to an exemplary embodiment of the present invention. FIGS. 4A to 4D are diagrams for describing the process of FIG. 3.

Referring to FIG. 3, the portable terminal enters a radio play mode in step 401. In step 402, the control unit 110 determines whether RT+ information is received from a broadcasting station. If the RT+ information is received from the broadcasting station, the control unit 110 proceeds to step 403; and if not, the control unit 110 repeats step 402. In step 403, the control unit 110 determines the type of the received RT+ information.

Specifically, in step 403, the control unit 110 determines the type of contents included in tag information of the received RT+ information.

In step 404, the control unit 110 determines whether the type of the contents included in the tag information of the RT+ information is music information (ITEM). If the type of the contents included in the tag information of the RT+ information is music information (ITEM), the control unit 110 proceeds to step 405; and if not, the control unit 110 proceeds to step 412. In step 405, the control unit 110 displays an information providing window for the music information.

Specifically, in step 405, the control unit 110 displays an information providing window for the music information in a predetermined region of a radio play screen displayed during the radio play mode, or displays the same in the form of a pop-up window.

Also, in step 405, the control unit 110 displays a music download menu and an information search menu in the information providing window for the music information.

In step 406, the control unit 110 determines whether the music download menu is selected from the information providing window for the music information. If the music download menu is selected from the information providing window for the music information, the control unit 110 proceeds to step 407; and if not, the control unit 110 proceeds to step 408. In step 407, the control unit 110 downloads in-play music by using the music information.

The music information may include Song Title (ITEM.TITLE), Singer Name (ITEM.ARTIST) and Text Location Information (Start Marker and Length Marker), and Song Title (ITEM.TITLE) and Singer Name (ITEM.ARTIST) may be divided in the text through the marker that is the text location information.

Table 2 below shows an example of the received music information when the text information of the RT+ information is “You are listening to ‘House of the rising sun’ by Eric Burdon” and the type of the contents included in the tag information of the RT+ information is music information (ITEM).

TABLE 2

| ′RT/eRT Content Type | ITEM.TITLE |
|---|---|
| Start Marker | 22 |
| Length Marker | 22 |
| ′RT/eRT Content Type | ITEM.ARTIST |
| Start Marker | 50 |
| Length Marker | 10 |

You are listening to ‘House of the rising sun’ by Eric Burdon
0----0----1----1----2----2----3----3----4----4----5----5----6----

Through the above music information, the control unit 110 may divide Song Title (ITEM.TITLE) and Singer Name (ITEM.ARTIST) in the text received together with the tag information of the RT+ information.

Thus, in step 407, the control unit 110 may use the music information (e.g., Song Title (ITEM.TITLE)) to provide a link of a service provider server capable of providing the music, and may access the service provider server to download the music.

In step 408, the control unit 10 determines whether the information search menu is selected from the information providing window for the music information. If the information search menu is selected, the control unit 110 proceeds to step 409; and if not, the control unit 110 proceeds to step 410. In step 409, the control unit 110 searches the portable terminal and a search site for the music information (Song Title (ITEM.TITLE) and Singer Name (ITEM.ARTIST) and displays the same.

In step 410, the control unit 110 determines whether a recording menu is selected during the playing of the music received from the broadcasting station in the radio play mode. If the recording menu is selected during the playing of the music received from the broadcasting station in the radio play mode, the control unit 110 proceeds to step 411; and if not, the control unit 110 returns to step 406.

In step 411, the control unit 110 stores the in-play music by automatically designating Song Title (ITEM.TITLE) of the music information as the music storage name, and inserts the music information (Song Title (ITEM.TITLE), Singer Name (ITEM.ARTIST) and Text Location Information (Start Marker and Length Marker)) into the stored music tag information.

Because the music information is inserted into the stored music tag information, the Song Title (ITEM.TITLE) and Singer Name (ITEM.ARTIST) for the music can be displayed when the stored music is played later.

The recording menu may be simultaneously displayed on the information providing window for the music information.

FIG. 4A illustrates an information providing window for the music information displayed in a predetermined region 400 of the radio play screen displayed in the radio play mode.

The information providing window for the music information in the predetermined region 400 of FIG. 4A displays a music download menu for providing a link to a service provider server to download the in-play music by using the music information, and an information search menu for searching for music information among the data stored in the portable terminal and a search site for the music information, together with the song title ‘House of the rising sun’.

In step 412, the control unit 110 determines whether the type of contents included in the tag information of the RT+ information is communication information (INTERACTIVITY). If the type of contents included in the tag information of the RT+ information is communication information (INTERACTIVITY), the control unit 110 proceeds to step 413; and if not, the control unit 110 performs a relevant function. In step 413, the control unit 110 displays an information providing window for providing the communication information.

The communication information may include Phone/Text Message (PHONE.STUDIO/PHONE.SMS), Access Site (WEBSITE.STUDIO), and E-mail (EMAIL.STUDIO).

Thus, in step 413, the control unit 110 determines the type of the communication information, and displays an information providing window corresponding to the type of the communication information in a predetermined region of the radio play screen or in the form of a pop-up window.

If the communication information is the Phone/Text Message (PHONE.STUDIO/PHONE.SMS), the control unit 110 detects this and displays an information providing window for connecting to the broadcasting station by using the Phone/Text Message, as illustrated in FIG. 4B.

In step 414, the control unit 110 determines whether a connection (Call or SMS) menu is selected from the information providing window of FIG. 4B. If the connection (Call or SMS) menu is selected from the information providing window, the control unit 110 proceeds to step 415; and if not, the control unit 110 repeats step 414. In step 415, the control unit 110 connects to the broadcasting station by transmitting a text message or by connecting a call by the phone number included in the communication information.

If the communication information is the Access Site (WEBSITE.STUDIO), the control unit 110 detects this and displays an information providing window for connecting to the broadcasting station by using the Access Site, as illustrated in FIG. 4C.

In step 414, the control unit 110 determines whether a connection (Go) menu is selected from the information providing window of FIG. 4C. If the connection (Go) menu is selected from the information providing window, the control unit 110 proceeds to step 415; and if not, the control unit 110 repeats step 414. In step 415, the control unit 110 connects to the broadcasting station by connecting by the website address included in the communication information.

If the communication information is the E-mail (EMAIL.STUDIO), the control unit 110 detects this and displays an information providing window for connecting to the broadcasting station by using the E-mail, as illustrated in FIG. 4D.

In step 414, the control unit 110 determines whether a connection (Send) menu is selected from the information providing window of FIG. 4D. If the connection (Send) menu is selected from the information providing window, the control unit 110 proceeds to step 415; and if not, the control unit 110 repeats step 414. In step 415, the control unit 110 connects to the broadcasting station by transmitting the E-mail address included in the communication information.

FIG. 3 illustrates a process for performing the functions corresponding to the music information (ITEM) and the communication information (INTERACTIVITY) among the content types included in the tag information of the RT+ information. However, the functions corresponding to other contents types than the music information (ITEM) and the communication information (INTERACTIVITY) included in the tag information of the RT+ information may be performed in the same way as illustrated in FIG. 3.

As described above, the present invention provides an apparatus and method for providing information in a portable terminal by using RT+ information received in a radio play mode of the portable terminal, thereby making it possible to conveniently download, search and record in-play music and to conveniently connect to a broadcasting station.

Note that the above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An apparatus for providing information in a portable terminal, comprising:
a display unit for displaying an information providing window for information received from a broadcasting station during a radio play mode of the portable terminal; and
a control unit for selectively providing a specific function responsive to the information received from the broadcasting station during the radio play mode.

2. The apparatus of claim 1, wherein the control unit displays the information providing window according to a type of the information received from the broadcasting station during the radio play mode.

3. The apparatus of claim 2, wherein the control unit displays the information providing window in a predetermined region of a radio play screen or in the form of a pop-up window during the radio play mode.

4. The apparatus of claim 2, wherein the information received from the broadcasting station is tag information of Radio Text (RT)+ information, and types of the information are divided according to content types included in the tag information.

5. The apparatus of claim 1, wherein if the information received from the broadcasting station is music information, the control unit displays the information providing window for displaying a music download menu for providing a link to a service provider server using the music information and an information search menu for searching music data stored in the portable terminal and a search site for the music information to provide a music-related function.

6. The apparatus of claim 1, wherein if the information received from the broadcasting station is music information and when a recording menu for in-play music is selected, the control unit stores the in-play music by automatically designating the music information as a music storage name, and inserts the music information into tag information of the music stored.

7. The apparatus of claim 5, wherein the music information includes Song Title and Singer Name.

8. The apparatus of claim 1, wherein if the information received from the broadcasting station is communication information, the control unit displays an information providing window for connecting to the broadcasting station by using the communication information, to provide communication-related information.

9. The apparatus of claim 8, wherein the communication information may include Phone/Text Message, Access Site, and E-mail.

10. A method for providing information in a portable terminal, comprising:
determining whether information is received from a broadcasting station during a radio play mode of the portable terminal; and
upon receiving the information from the broadcasting station, providing a specific function responsive to the received information.

11. The method of claim 10, further comprising displaying an information providing window according to a type of the information received from the broadcasting station during the radio play mode.

12. The method of claim 11, wherein the information providing window is displayed in a predetermined region of a radio play screen during or in the form of a pop-up window during the radio play mode.

13. The method of claim 11, wherein the information received from the broadcasting station is tag information of Radio Text (RT)+ information, and types of the information are divided according to content types included in the tag information.

14. The method of claim 10, wherein the providing of the specific function comprises:
displaying an information providing window for providing a music download menu and an information search menu when the information received from the broadcasting station is music information;
providing a link to a service provider server for downloading in-play music when the music download menu is selected; and
searching the portable terminal [waiting for replay] and a search site for the music information when the information search menu is selected.

15. The method of claim 10, wherein the providing of the function comprises storing, if the information received from the broadcasting station is music information and when a recording menu for in-play music is selected, the in-play music by automatically designating the music information as a music storage name.

16. The method of claim 15, further comprising inserting the music information into tag information of the music stored when the in-play music is stored.

17. The method of claim 14, wherein the music information includes Song Title and Singer Name.

18. The method of claim 10, wherein the providing of the function comprises:
if the information received from the broadcasting station is communication information, determining a type of the communication information;
if the type of the communication information is Phone/Text Message, displaying an information providing window for connecting to the broadcasting station through the Phone/Text Message;
if the type of the communication information is Access Site, displaying an information providing window for connecting to the broadcasting station through the Access Site; and
if the type of the communication information is E-mail, displaying an information providing window for connecting to the broadcasting station through the E-mail.

19. A portable terminal for providing information, comprising:
a display unit for displaying an information window responsive to information received from a broadcasting station during a radio play mode; and
a control unit for providing a specific function window according to a type of the information received from the broadcasting station.

20. The portable terminal of claim 19, wherein if the information received from the broadcasting station is music information, the control unit displays the specific function window for displaying a music download menu for providing a link to a service provider server.

21. The portable terminal of claim 19, wherein if the information received from the broadcasting station is communication information, the control unit displays the specific function window for connecting to the broadcasting station.
